(19) United States
(12) Patent Application Publication
(10) Pub. No.: US 2018/0204185 A1
(43) Pub. Date: Jul. 19, 2018

(54) SYSTEMS AND METHODS FOR EMPLOYMENT CANDIDATE ANALYSIS

(71) Applicant: Modis, Inc., Jacksonville, FL (US)

(72) Inventor: Andrew John FERNHOLZ, Minneapolis, MN (US)

(73) Assignee: Modis, Inc.

(21) Appl. No.: 15/405,928

(22) Filed: Jan. 13, 2017

(51) Int. Cl. G06Q 10/10

(52) U.S. Cl. CPC G06Q 10/1053; G06F 17/30528

(57) ABSTRACT

A method for assessing an individual for a job, comprising: defining a plurality of primary traits related to the job; attributing a primary weighting value to each of the plurality of primary traits, wherein at least one of the plurality of primary traits is assigned a primary weighting value different than a primary weighting value assigned to another of the plurality of primary traits; determining a plurality of scoring values for the individual for the plurality of primary traits, wherein each of the plurality of scoring values corresponds to one of the plurality of primary traits; and calculating a total assessment score based at least in part on the determined plurality of scoring values and the primary weighting values.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present disclosure relates to methods and systems for assessing employment candidates and/or current employees for specific job classifications and projects, including, for example, methods and systems for efficiently and quickly identifying an individual's ability to perform a work function specific to an employer's culture, goals, technology landscape and/or work style.

### BACKGROUND OF THE INVENTION

High employee turnover and/or placement of employees into roles they may be ill-suited for can drastically affect a company's success—from eroding profits and competitive advantage, delaying the release of new products, and loss of corporate resources, to adversely affecting company culture and overall business failure. Despite having such a material impact on a company's success, shortcomings routinely permeate hiring processes and analysis of candidates that perpetuates mis-selection of candidates, such as lackluster interviewing skills, poor resource selection, and/or routinely engaging in a high number of interviews prior to making a human resource selection. Improved candidate and employee analysis and selection is needed in virtually all fields to remain competitive.

### SUMMARY OF THE INVENTION

The present disclosure advantageously provides a method for assessing an individual for a job, including: defining a plurality of primary traits related to the job; attributing a primary weighting value to each of the plurality of primary traits, wherein at least one of the plurality of primary traits is assigned a primary weighting value different than a primary weighting value assigned to another of the plurality of primary traits; determining a plurality of scoring values for the individual for the plurality of primary traits, wherein each of the plurality of scoring values corresponds to one of the plurality of primary traits; and calculating a total assessment score based at least in part on the determined plurality of scoring values and the primary weighting values. Each weighting value may include a numerical value between one and ten. The plurality of primary traits may be selected from the group consisting of: technical skills; communications skills/influence/persuasion; delivery focus; planning/organizing/priority setting; action orientation/self-motivation; and adapting to the environment/organizational fit. Determining a plurality of scoring values for the individual for the plurality of primary traits may include calculating scores for each primary trait based at least in part on a plurality of scoring values for a plurality of secondary traits. Determining a plurality of scoring values for each of the plurality of primary traits may include: presenting a plurality of questions to the individual, wherein each of the plurality of questions has a predetermined maximum scoring value; receiving a response to each of the plurality of questions from the individual; assigning a scoring value to each of the received responses; and calculating at least one of a ratio and percentage value for each of the assigned scoring values to each respective predetermined maximum scoring value. Determining a plurality of scoring values for each of the plurality of primary traits may further include multiplying the calculated ratio or percentage value by a secondary weighted value. The plurality of questions may include multiple-choice questions that each have a plurality of responses each having a predefined scoring value.

A method for assessing an individual for a job is provided, including: defining a plurality of primary traits related to the job; attributing a primary weighting value to each of the plurality of primary traits, wherein at least one of the plurality of primary traits is assigned a primary weighting value different than a primary weighting value assigned to another of the plurality of primary traits; determining a first plurality of scoring values for the individual for the plurality of primary traits with a first evaluator, wherein each of the first plurality of scoring values corresponds to one of the plurality of primary traits; calculating a first total assessment score based at least in part on the determined first plurality of scoring values and the primary weighting values; determining a second plurality of scoring values for the individual for the plurality of primary traits with a first evaluator, wherein each of the second plurality of scoring values corresponds to one of the plurality of primary traits; calculating a second total assessment score based at least in part on the determined second plurality of scoring values and the primary weighting values; and calculating an overall assessment score based at least in part on the calculated first and second total assessment scores. Each weighting value may include a numerical value between one and ten. Determining a plurality of first and second scoring values may include calculating scores for each primary trait based at least in part on a plurality of scoring values for a plurality of secondary traits. Calculating an overall assessment score may include at least one of calculating an average and a sum of the first and second total assessment scores.

A method for assessing an individual for a job is disclosed, including: retrieving a first plurality of questions from an electronically-stored database, wherein the first plurality of questions is associated with a first primary trait related to the job; retrieving a second plurality of questions from the electronically-stored database, wherein the second plurality of questions is associated with a second primary trait related to the job; presenting the first and second pluralities of questions to the individual through a user interface in communication with the database; receiving a response to each of the first and second pluralities of questions from the individual; assigning a scoring value to each of the received responses; calculating, with a processor in communication with the user interface, a first assessment value based at least in part on the scoring values assigned to the responses to the first plurality of questions and a first weighted value associated with the first primary trait; calculating, with the processor, a second assessment value based at least in part on the scoring values assigned to the responses to the second plurality of questions and a second weighted value associated with the second primary trait, wherein the second weighted value is different from the first weighted value; and calculating a total assessment score based at least in part on the first and second assessment values. Each of the first plurality of questions may be associated with a predetermined maximum scoring value, and assigning a scoring value to each of the received responses may include assigning a score based at least in part on the predetermined maximum scoring value. Calculating a first assessment value may include calculating at least one of a ratio and percentage value for each of the assigned scoring values to each respective predetermined maximum scoring value. Calculating a first assessment value may further include multiplying the calculated ratio or percentage value by a third weighted value. Assigning a scoring value to each of the received responses may include comparing the received responses to a plurality of stored responses having predetermined scoring values. The first plurality of questions may include a plurality of questions associated with a first plurality of secondary traits associated with the first primary trait, and/or the second plurality of questions may include a plurality of questions associated with a second plurality of secondary traits associated with the second primary trait.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a block diagram of an example of a system constructed in accordance with the principles of the present disclosure;

FIG. 2 includes examples of primary trait categories and subcategories and weighting values in accordance with the principles of the present disclosure;

FIG. 3 includes examples of secondary trait categories and subcategories, and scoring and weighting values in accordance with the principles of the present disclosure;

FIG. 4 includes an example of a scorecard for an evaluator in accordance with the principles of the present disclosure; and

FIG. 5 includes an example of a scorecard for multiple evaluators in accordance with the principles of the present disclosure.

### DETAILED DESCRIPTION OF THE INVENTION

The present disclosure provides systems and methods for assessing a potential individual's or resource's ability to perform and likelihood of top performance in a particular position or field, which allows employers to effectively evaluate both potential and existing staff, identify gaps in resources, and allow for effective performance improvement plans or identify staff that lacks a certain competency. The methods and systems disclosed herein provide a multi-tiered assessment and scoring process that may be implemented by companies or staffing companies to improve hiring efficiencies and long term retention of said resources.

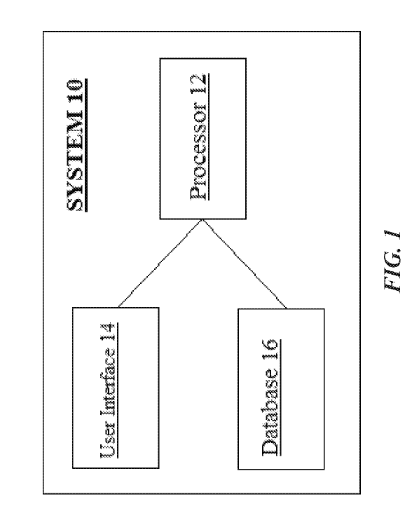

Now referring to the figures, in which like reference designators refer to like components, FIG. 1 is a block diagram of an example of a candidate assessment system 10 constructed in accordance with principles of the present disclosure, which includes a processor 12 that is configured and operable to perform the various features of the methods and processes disclosed herein. The system 10 generally includes a user interface 14 that enabled the system to receive inputs from, and generate output to, various users, applicants, or clients utilizing the system. The interface may include, for example, one or more visual interfaces as well as input devices, including but not limited to, personal computers, tablets, smart phones, or the like. The system 10 may also include a database 16 containing a plurality of interview categories, topics, related questions, scoring weights, and/or exemplary responses that can be stored and accessed as disclosed herein. The processor 12, user interface 14, and the database 16 may all be in communication with each other, either directly within a single computing device or system, or in multiple computing devices or systems in communication across one or more networks spanning multiple locations.

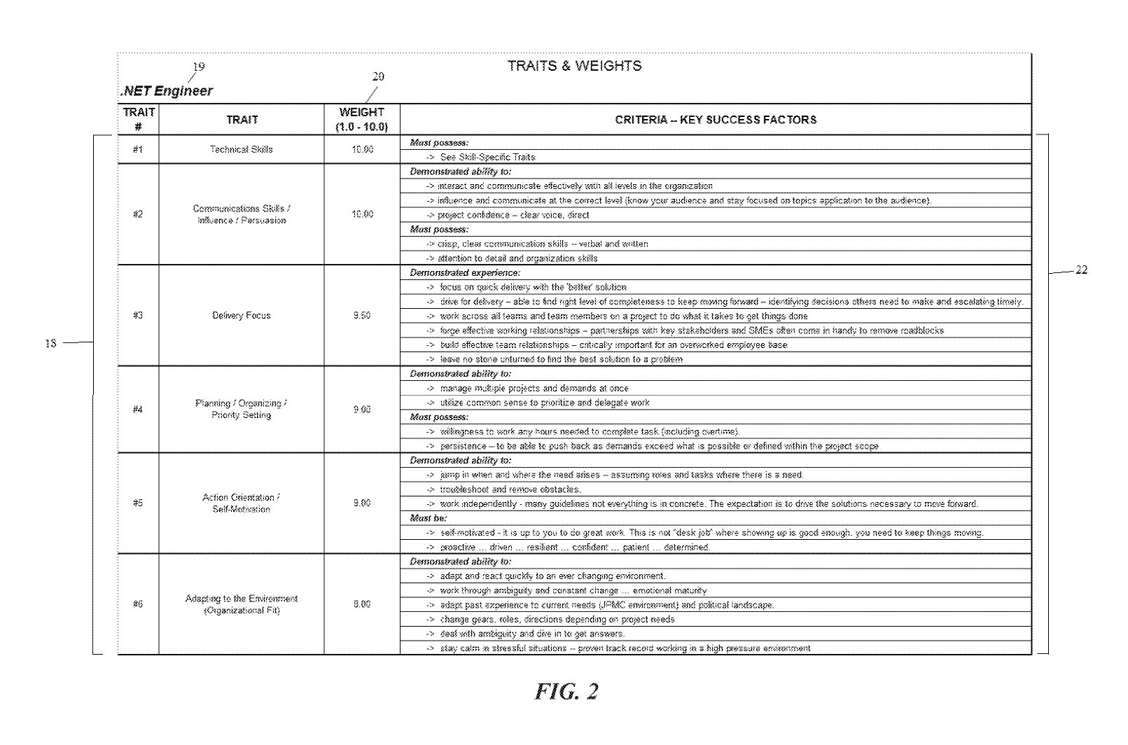

The system 10 may include a plurality of primary categories or traits 18 for a position, job, or task 19 that an interviewee and/or employment candidate may be assessed for. These categories 18 may be stored, modified, and/or accessed via the database 16. The primary categories 18 may include, for example, traits related to direct task-related or performance skills as well as company culture and/or personality fit within a given company's working environment. As shown in FIG. 2, such primary categories 18 may include, for example, one or more characteristics or attributes related to: technical skills; communications skills/influence/persuasion; delivery focus; planning/organizing/priority setting; action orientation/self-motivation; and/or adapting to the environment/organizational fit. Additional and/or alternative categories may be implemented for a particular employment position and/or company seeking particular, specialized traits in an interviewee or other candidate.

Each primary category 18 may be assigned or ascribed an assessment weighting value 20 that may vary amongst the individual primary categories. The assessment weighting value may be a numerical value that can bias or weight an overall scoring or mathematical valuation towards a particular category 18 versus another category 18 in the assessment process, as described herein. For example, the weighting value 20 may be a numerical value between the numbers 1 and 10, where a higher number reflects a more heavily-weighted category 18 corresponding to a more heavily-favored or desired category of traits that an interviewee should have for the particular position 19 and/or company at issue.

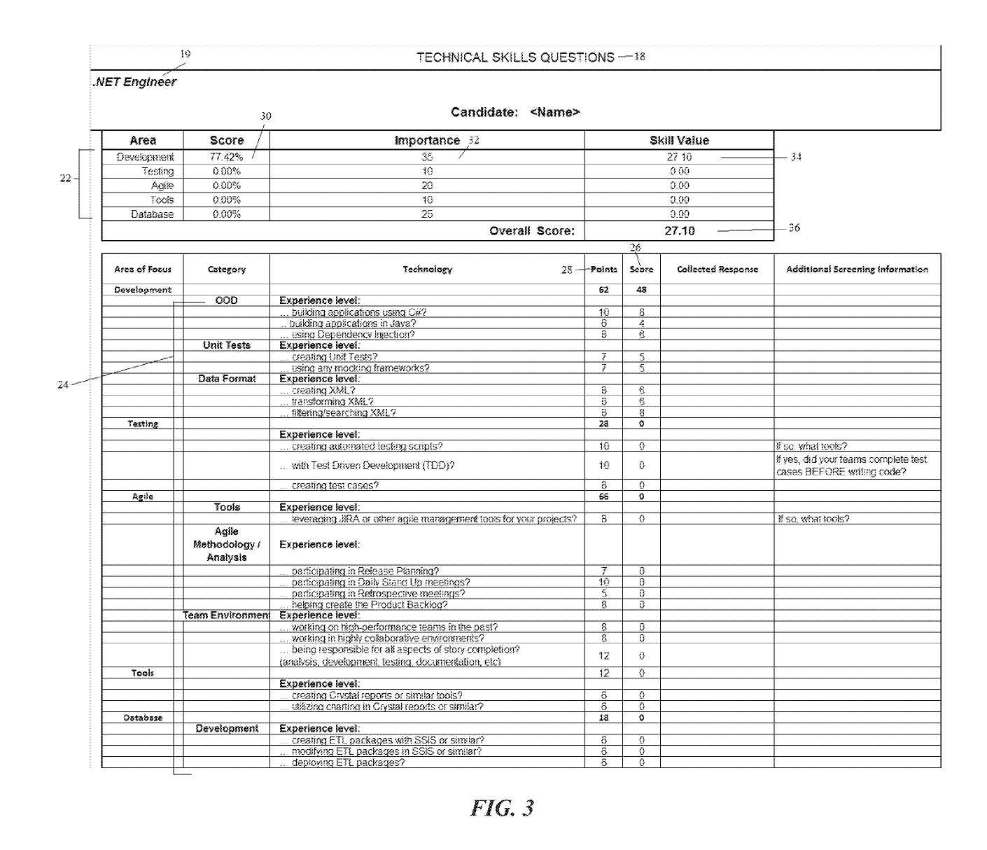

Now referring to FIG. 3, the system 10 may include a plurality of secondary categories or traits 22 for each primary category or trait 18 that further delineate, identify, or aid in assessing each interviewee or candidate for the attributes of the primary category or trait 18. For example, the illustrated “technical Skill” category 18 may include subcategories 22 of “development,” “testing,” “agile,” “tools”, and “database.” These categories 22 may be stored, modified, and/or accessed via the database 16.

Each secondary category 22 may include a plurality of questions or topics 24 to be discussed with an interviewee or candidate, where each question or topic 24 is ascribed a numerical score 26 out of a total number of scoring points available 28 for each question or topic 24. The individual score for each question or topic 24 underlying the secondary category 22 can then be tabulated to provide a score for the designated secondary category 22 (e.g., secondary category “Development” includes a plurality of questions/topics that can provide a total available score of 62 points). A ratio or percentage 30 of the score 26 with respect to the total score available 28 for a particular secondary trait 22 can be calculated and attributed to each of the secondary categories or traits 22 (e.g., the “development” score in the illustrated example was 48/62, correlating to 77.42%).

Each secondary category 22 may be assigned or ascribed a secondary weighting or importance value 32 that may vary amongst the individual secondary categories. The secondary weighting value 32 may include a numerical value that can bias or weight an overall scoring or mathematical valuation towards a particular category 22 versus another category 22 in the assessment process, as described herein. For example, the secondary weighting value 32 may be a numerical value between the numbers 1 and 10, where a higher number reflects a more heavily-weighted secondary category 22 corresponding to a more heavily-favored or desired category of traits that an interviewee should have for the particular position 19 and/or company at issue. Alternatively, the weighting value 32 may include a numerical value that is a portion of a total percentage or preset value (e.g., in FIG. 3, the weighting values are differing values adding up to a total value of 100).

The weighting value 32 and the ratio or percentage 30 for each secondary category 22 may be used to assess and calculate a secondary category value 34 for each individual secondary category 22. The secondary category value may be calculated, for example, by multiplying the weighting value 32 by the ratio or percentage 30. Alternative calculations may include using quotient, linear, exponential, or other mathematical processes to arrive at each secondary category value 34.

Further assessment, calculation, and/or tabulation of all of the secondary category values 34 may be performed to provide an overall score 36 for the particular primary category 18 correlating to the secondary categories 22 being assessed and scored. For example, the example shown in FIG. 3 shows a summation of all of the secondary category values 34 to arrive at a score of “27.10” for the “Technical Skills” primary category 18. A similar process may be instituted for scoring each other primary category 18.

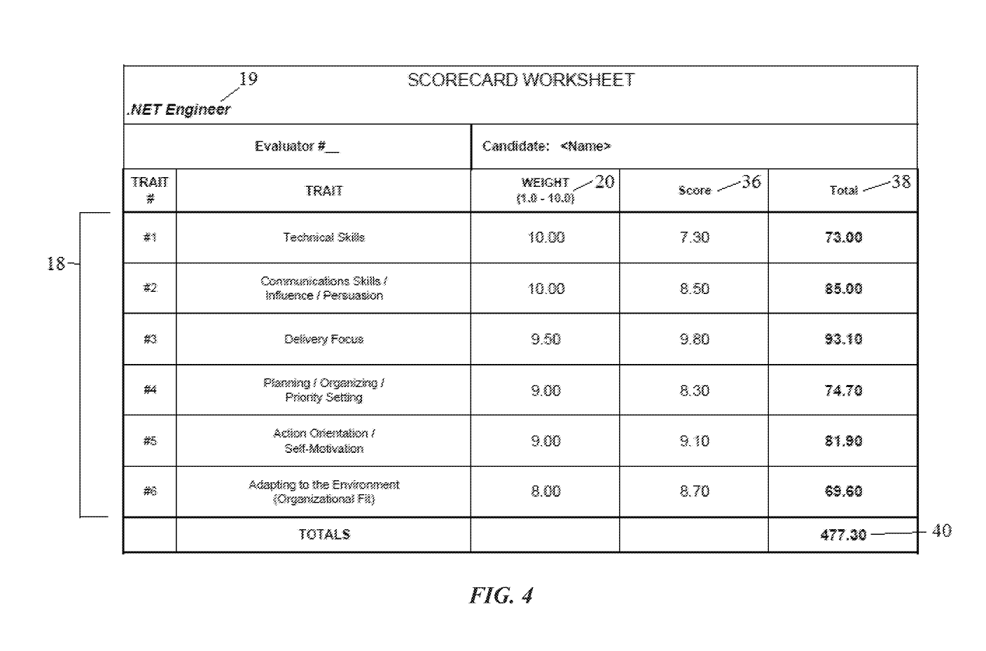

Now referring to FIG. 4, the overall score 36 for each primary category 18 may be processed, calculated, and/or tabulated in conjunction with the assessment weighting value 20 affiliated with that particular primary category 18 to obtain a weighted primary category score 38. For example, the weighted primary category score 38 may be calculated by multiplying the overall score 36 by the assessment weighting value 20. Alternative calculations may include using quotient, linear, exponential, or other mathematical processes to arrive at each weighted primary category score 38.

A total assessment score 40 may be processed, calculated, and/or tabulated from the totality of the weighted primary category scores 38 for all of the primary categories 18. For example, the total assessment score 40 may simply be a sum of all of the weighted primary category scores 38 for a particular interviewee.

The presentation and administration of the various questions, categories, and subcategories described herein may be performed through an automated, computerized process and/or by one or more evaluators (which may include human resources personnel, technical personnel, company designees, or the like) having experience in the particular field or area related to the position 19. The automated, computerized process may include presenting various multiple-choice questions having answers with predefined or predetermined scoring values, and/or may include text recognition and search algorithms to analyze, compare, and score an interviewee's free-form responses to posed questions, categories, and topics. In an example where in-person evaluators conduct the assessment and scoring, such scoring can be determined based on the evaluators' knowledge in the particular field and/or as compared to predefined responses having designated scoring values.

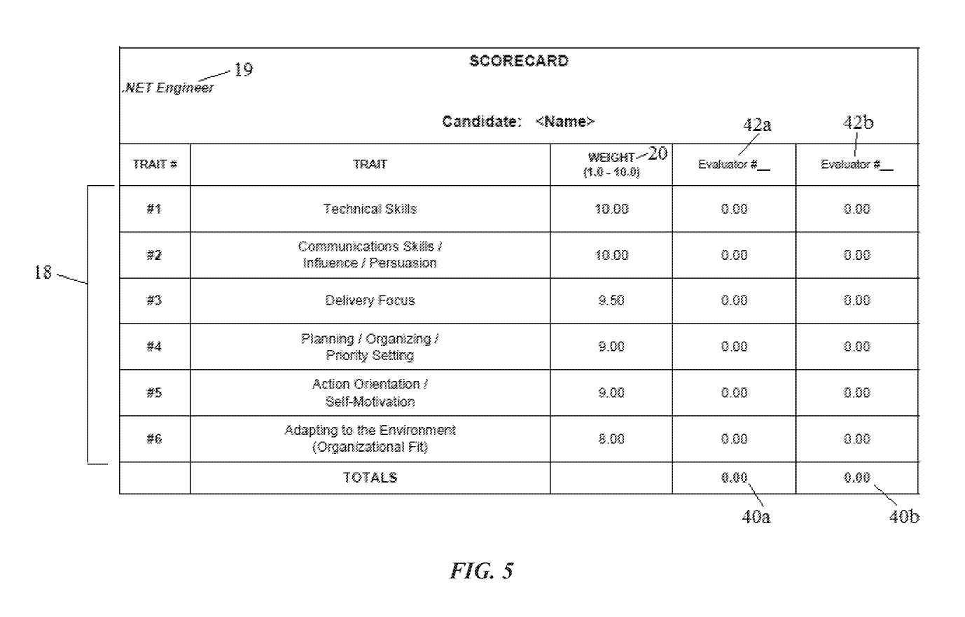

Multiple evaluators may be implemented to assess an interviewee or candidate, and/or an in-person evaluator may conduct an assessment in conjunction with an automated, computerized assessment, in an effort normalize an interviewee's scoring and assessment and reduce any subjectivity or inherent bias that a single evaluator may have. In such an example, as shown in FIG. 5, total assessment scores 40a and 40b may be calculated by evaluators 42a and 42b, respectively, and tabulated, summed, or otherwise processed to determine a combined assessment score for the interviewee. Such a combined score may include, for example, the sum of the two scores 40a, 40b; an average of the scores 40a, 40b; and/or other mathematical process or algorithm taking into account the two separate scores.

The system 10 may include one or more predefined threshold scores for the various values and scores associated with the primary categories 18, the secondary categories 22, and/or the questions/topics 24 underlying each secondary category 22. The actual scored values for an interviewee or candidate may be compared to the threshold scores at an early stage in the interview or assessment process to determine whether a particular candidate moves onto subsequent interviewing processes or interactions, and can thus preserve resources for only the most qualified candidates.

The assessments, calculations, and scoring of the various values described herein may be facilitated through the presentation and/or orientation of the various categories, questions, values, and the like in a scorecard or table-like format, as shown in the figures. Such scorecards or tables may include additional fields or areas to record additional observations, notes, or the like relevant to the information solicited and/or provided by an interviewee or candidate (e.g., “Collected Response,” and/or “Additional Screening Information”). The scorecard or table-like format may be provided to an interviewer digitally by the user interface 14, and the calculations described herein may be performed by the processor 12 of the system 10.

In today's global economy and talent being tougher and tougher to find and match to appropriate corporations, the need to quickly identify and qualify resources is paramount to the success of client companies. Many companies are challenged to attract talented resources but are also challenged with how to qualify, train, select and hire the right talent quickly and effectively. The multi-tiered scoring systems and processes disclosed herein aid in identifying and evaluating the competency level of an individual to perform a specific work function. The algorithms herein produce numerical scores for the individual that can be efficiently and systematically compared and evaluated, thus drastically improving hiring efficiencies and quality of resource selection that can deliver significant cost savings.

The present invention can be realized in hardware, software, or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device such as magnetic storage, solid state storage, semiconductor memory, DVD, Compact Disk or memory stick.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

Program code may be transmitted to a computer constructed in accordance with the principles of the present invention using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. It is noted that the computer programs of the present invention can be downloaded via the Internet to a computer, such as network device and/or target host system, having a TCP/IP-based network adapter card for installation in the computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The term “computer-readable storage device” does not encompass a signal propagation media such as a copper cable, optical fiber or wireless transmission media.

It will be appreciated by persons skilled in the art that the present disclosure is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the disclosure. A variety of modifications and variations are possible in light of the above teachings without departing from the scope and spirit of the disclosure, which is limited only by the following claims.

What is claimed is:

1. A method for assessing an individual for a job, comprising:
defining a plurality of primary traits related to the job;
attributing a primary weighting value to each of the plurality of primary traits, wherein at least one of the plurality of primary traits is assigned a primary weighting value different than a primary weighting value assigned to another of the plurality of primary traits;
determining a plurality of scoring values for the individual for the plurality of primary traits, wherein each of the plurality of scoring values corresponds to one of the plurality of primary traits; and
calculating a total assessment score based at least in part on the determined plurality of scoring values and the primary weighting values.

2. The method of claim 1, wherein each weighting value is a numerical value between one and ten.

3. The method of claim 1, wherein the plurality of primary traits is selected from the group consisting of: technical skills; communications skills/influence/persuasion; delivery focus; planning/organizing/priority setting; action orientation/self-motivation; and adapting to the environment/organizational fit.

4. The method of claim 1, wherein determining a plurality of scoring values for the individual for the plurality of primary traits includes calculating scores for each primary trait based at least in part on a plurality of scoring values for a plurality of secondary traits.

5. The method of claim 1, wherein determining a plurality of scoring values for each of the plurality of primary traits includes:
presenting a plurality of questions to the individual, wherein each of the plurality of questions has a predetermined maximum scoring value;
receiving a response to each of the plurality of questions from the individual;
assigning a scoring value to each of the received responses; and
calculating at least one of a ratio and percentage value for each of the assigned scoring values to each respective predetermined maximum scoring value.

6. The method of claim 5, wherein determining a plurality of scoring values for each of the plurality of primary traits further includes multiplying the calculated ratio or percentage value by a secondary weighted value.

7. The method of claim 5, wherein the plurality of questions are multiple-choice questions that each have a plurality of responses each having a predefined scoring value.

8. A method for assessing an individual for a job, comprising:
defining a plurality of primary traits related to the job;
attributing a primary weighting value to each of the plurality of primary traits, wherein at least one of the plurality of primary traits is assigned a primary weighting value different than a primary weighting value assigned to another of the plurality of primary traits;
determining a first plurality of scoring values for the individual for the plurality of primary traits with a first evaluator, wherein each of the first plurality of scoring values corresponds to one of the plurality of primary traits;
calculating a first total assessment score based at least in part on the determined first plurality of scoring values and the primary weighting values;
determining a second plurality of scoring values for the individual for the plurality of primary traits with a first evaluator, wherein each of the second plurality of scoring values corresponds to one of the plurality of primary traits;
calculating a second total assessment score based at least in part on the determined second plurality of scoring values and the primary weighting values; and
calculating an overall assessment score based at least in part on the calculated first and second total assessment scores.

9. The method of claim 8, wherein each weighting value is a numerical value between one and ten.

10. The method of claim 8, wherein determining a plurality of first and second scoring values includes calculating scores for each primary trait based at least in part on a plurality of scoring values for a plurality of secondary traits.

11. The method of claim 8, wherein calculating an overall assessment score includes at least one of calculating an average and a sum of the first and second total assessment scores.

12. A method for assessing an individual for a job, comprising:
retrieving a first plurality of questions from an electronically-stored database, wherein the first plurality of questions is associated with a first primary trait related to the job;
retrieving a second plurality of questions from the electronically-stored database, wherein the second plurality of questions is associated with a second primary trait related to the job;
presenting the first and second pluralities of questions to the individual through a user interface in communication with the database;
receiving a response to each of the first and second pluralities of questions from the individual;
assigning a scoring value to each of the received responses;
calculating, with a processor in communication with the user interface, a first assessment value based at least in part on the scoring values assigned to the responses to the first plurality of questions and a first weighted value associated with the first primary trait;
calculating, with the processor, a second assessment value based at least in part on the scoring values assigned to the responses to the second plurality of questions and a second weighted value associated with the second primary trait, wherein the second weighted value is different from the first weighted value; and
calculating a total assessment score based at least in part on the first and second assessment values.

13. The method of claim 12, wherein each of the first plurality of questions is associated with a predetermined maximum scoring value, and wherein assigning a scoring value to each of the received responses includes assigning a score based at least in part on the predetermined maximum scoring value.

14. The method of claim 13, wherein calculating a first assessment value includes calculating at least one of a ratio and percentage value for each of the assigned scoring values to each respective predetermined maximum scoring value.

15. The method of claim 14, wherein calculating a first assessment value further includes multiplying the calculated ratio or percentage value by a third weighted value.

16. The method of claim 12, wherein assigning a scoring value to each of the received responses includes comparing the received responses to a plurality of stored responses having predetermined scoring values.

17. The method of claim 12, wherein the first plurality of questions includes a plurality of questions associated with a first plurality of secondary traits associated with the first primary trait.

18. The method of claim 17, wherein the second plurality of questions includes a plurality of questions associated with a second plurality of secondary traits associated with the second primary trait.
